(19) United States
(12) Patent Application Publication
(10) Pub. No.: US 2013/0282400 A1
(43) Pub. Date: Oct. 24, 2013

(54) SYSTEM AND METHOD FOR UPLOADING AND AUTHENTICATING MEDICAL IMAGES

(71) Applicant: WOUNDMATRIX, INC., Chadds Ford, PA (US)

(72) Inventor: Osama H. Al-Moosawi, Bear, DE (US)

(73) Assignee: WOUNDMATRIX, INC., Chadds Ford, PA (US)

(21) Appl. No.: 13/867,683

(22) Filed: Apr. 22, 2013

Related U.S. Application Data
(60) Provisional application No. 61/636,142, filed on Apr. 20, 2012.

(51) Int. Cl. G06F 19/00; G06Q 50/24

(52) U.S. Cl. CPC G06F 19/321; G06Q 50/24
USPC 705/3

(57) ABSTRACT

Systems, methods and computer-readable storage media for securely authenticating client computing devices and receiving medical information at a medical information system are described. Patients and client computing devices associated with the patients may be enrolled with the medical information system. A client computing device may capture medical information, such as an image of a portion of the body of medical significance (for example, a wound). The client computing device may be authenticated by the medical information system by matching information in a client computing device authentication request with information in a device database accessible by the medical information system. Once authenticated, the client computing device may send an upload request to the medical information system including medical information. The medical information system may store the medical information in an associated patient profile in a patient database.

### CROSS REFERENCE TO RELATED APPLICATIONS

This application claims priority under 35 U.S.C. §119(e) to U.S. Provisional Application No. 61/636,142, filed on Apr. 20, 2012, the content of which are incorporated by reference in its entirety as if fully set forth herein.

### BACKGROUND

Recent advances in medical imaging technology have allowed medical professionals to collaborate on more projects than were previously possible. For example, a medical technician working in a healthcare facility can quickly forward medical information, such as a medical image, for evaluation by a doctor located practically anywhere in the world. The ability to instantly share medical information has improved the efficiency and cost-effectiveness of providing healthcare among medical professionals.

A major concern within the healthcare industry is maintaining secure and accurate medical information and ensuring patient privacy. The inability to provide secure and accurate methods for capturing and transmitting medical information directly from patients has limited the use of medical image capturing to those working in the medical fields. As such, medical imaging technology has not expanded beyond use in medical facilities to use by patients in their homes, caregivers providing homecare to patients, and in-patient and out-patient treatment facilities and providers. Therefore, it would be beneficial for a healthcare provider to facilitate remote medical information capture and transmission for patients and other individuals assisting in their medical care in a manner that is both secure and accurate.

### BRIEF DESCRIPTION OF THE DRAWINGS

FIG. 1 depicts an illustrative medical information system according to some embodiments.

FIG. 2 depicts an illustrative client computing device configured to operate with a medical information system according to some embodiments.

FIG. 3 depicts a flow diagram of an illustrative method of receiving medical information at a medical information system according to an embodiment.

FIG. 4 illustrates a flow diagram of an illustrative process for authenticating a client computing device according to an embodiment.

FIG. 5 depicts a flow diagram of an illustrative method for uploading images from a client computing device according to an embodiment.

FIG. 6 depicts a block diagram of illustrative internal hardware that may be used to contain or implement program instructions according to an embodiment.

### SUMMARY

This disclosure is not limited to the particular systems, devices and methods described, as these may vary. The terminology used in the description is for the purpose of describing the particular versions or embodiments only, and is not intended to limit the scope.

It must be noted that as used herein and in the appended claims, the singular forms “a,” “an,” and “the” include plural reference unless the context clearly dictates otherwise. Unless defined otherwise, all technical and scientific terms used herein have the same meanings as commonly understood by one of ordinary skill in the art. As used herein, the term “comprising” means “including, but not limited to.”

In an embodiment, a system for securely receiving medical information from at least one client computing device may comprise a processor and a non-transitory, computer-readable storage medium in operable communication with the processor. The computer-readable storage medium may contain one or more programming instructions that, when executed, cause the processor to receive at least one request from the at least one client computing device. The at least one request may comprise authentication information and medical information. The one or more programming instructions, when executed, may further cause the processor to access a device database configured to store device information associated with each client computing device registered with the system, authenticate the at least one client computing device responsive to locating device information associated with the authentication information, and access a patient database responsive to authentication of the at least one client computing device, the patient database configured to store patient information associated with each patient registered with the system, authenticate a patient responsive to locating an existing patient profile associated with the at least one request in the patient database, and store at least a portion of the medical information in the existing patient profile.

In an embodiment, a computer-implemented method for securely receiving medical information from at least one client computing device may comprise, by a processor, receiving at least one request from the at least one client computing device, the at least one request comprising authentication information and medical information, accessing a device database configured to store device information associated with each client computing device enrolled with the system, authenticating the at least one client computing device responsive to locating device information associated with the authentication information, accessing a patient database responsive to authentication of the at least one client computing device, the patient database configured to store patient information associated with each patient enrolled with the system, authenticating a patient associated responsive to locating an existing patient profile associated with the at least one request in the patient database, and storing at least a portion of the medical information in the existing patient profile.

In an embodiment, a computer-readable storage medium having computer-readable program code configured to securely receive medical information from at least one client computing device embodied therewith, the computer-readable program code comprising computer-readable program code configured to receive at least one request from the at least one client computing device, the at least one request comprising authentication information and medical information, computer-readable program code configured to access a device database configured to store device information associated with each client computing device registered with the system, computer-readable program code configured to authenticate the at least one client computing device responsive to locating device information associated with the authentication information, computer-readable program code configured to access a patient database responsive to authentication of the at least one client computing device, the patient database configured to store patient information associated with each patient registered with the system, computer-readable program code configured to authenticate a patient responsive to locating an existing patient profile associated with the at least one request in the patient database, and computer-readable program code configured to store at least a portion of the medical information in the existing patient profile.

### DETAILED DESCRIPTION

The present technology is directed to methods, systems and computer-readable storage media for securely and accurately transmitting medical information from a client computing device to a medical information system. In an embodiment, the medical information may include information obtained by a user. In a non-limiting example, a user may generate an image of a portion of the body of medical significance (e.g., a portion having a wound or other injury) and may store, at least temporarily, the image on the client computing device. In some embodiments, the client computing device may be used to obtain the medical information, such as through a camera, microphone, or other device operatively coupled to the client computing device. The user may initiate a secure connection with the medical information system by transmitting an authentication request. If the client computing device is authenticated, the user may transmit an upload request configured to send the medical information to the medical information system. The medical information system may be configured to process the upload request, such as by uploading files and/or other data included in the upload request, responsive to authenticating the patient associated with the client computing device, authentication request, and/or upload request. Once the upload request has been processed, the medical information system may be configured to store the files and/or other data in a patient database in a record, profile, or other data structure associated with the patient.

The following terms shall have, for the purposes of this application, the respective meanings set forth below.

“Medical information” generally refers to information of a medical nature associated with a patient or healthcare entity. Medical information may be included in various forms. Illustrative and non-restrictive examples of forms of medical information include, image files, video files, audio files, electronic documents (including digital, “scanned” forms of paper documents), various forms of medical data (for example, electrocardiogram (EKG) data, blood pressure data, or the like), databases and database records, or combinations thereof. Medical information may include information pertaining to one or more medical conditions associated with a patient, such as an image of an injury, a description of symptoms (for example, stored in an electronic document or recorded in an audio file), data from a medical device (for example, an EKG device, a blood pressure monitor or cuff, a blood sugar monitor, a pulse oximeter, a stethoscope, a pedometer or other human movement monitor, or the like), patient fluid test results (e.g., blood test, urine test or the like), or combinations thereof.

An “image” or “medical image” generally refers to an image of medical significance, including, without limitation, a wound, a scar, a burn, a mole, a growth, an anomaly, or other similar malady of a bodily area of medical concern of a patient. Images may additionally include diagnostic images obtained using diagnostic imaging equipment. Non-limiting examples of diagnostic imaging equipment include ultrasound systems, computed tomography (CT) systems, magnetic resonance imaging (MRI) systems, x-ray systems, positron emission tomography (PET) system, or the like.

A “client computing device” generally refers to any logic or computing device capable of establishing communication with the medical information system. A client computing device may be configured in various form factors, such as laptops, personal computers (PCs), servers, and/or mobile computing devices. In general, a mobile computing device may generally include any portable computing device capable of connecting to a communications network for the purposes of transmitting and receiving data. Examples of mobile devices may include, but are not limited to, notebook computers, netbook computers, tablet computers, personal digital assistants (PDAs), cellular telephones, smartphones (i.e., a cellular telephone with an integrate mobile operating system incorporating additional features beyond those of a standard cellular telephone), and other similar devices.

A “medical information capturing device” refers to any device capable of capturing medical information. A medical information device may include a device integrated into a client computing device, such as a camera, microphone and/or photo sensor configured to transfer captured image and/or audio data to a computer readable memory device and embedded within the client computing device. A medical information device may also include a stand-alone device, such as a device configured to analyze and/or measure certain aspects of a patient, such as a blood-pressure monitor. Stand-alone devices may be operatively coupled with a client computing device such that medical information captured thereby may be transferred and stored, at least temporarily, on the client computing device for transmission to the medical information system. As used herein, an “image capturing device” may refer to a digital image capture device. Additionally, the image capture device may be integrated into a mobile and wireless digital device.

The technology relates to authenticating a client computing device and uploading medical information acquired by the client computing device to a data server of the medical information system. The client computing device may be used by a patient or caregiver to capture and define medical information such that repeated trips to a doctor's office or other healthcare facility are avoided for routine check-ups for a healing wound or other area of concern. In a non-limiting example, the client computing device may provide a portable means for documenting a patient's wound care or monitoring of any other medical condition, such as a mole.

The client computing device may be a device owned by the patient, such as the patient's smartphone. A medical professional, caregiver or medical provider may install appropriate software, such as a downloadable application (for example, a “mobile application,” “mobile app,” or “app”), onto the patient's medical device and review the software with the patient, including the steps followed to capture, define and upload a medical image. In another example, the client computing device may access an application over a network (for example, through a web-based application or a software-as-a-service (SaaS) platform). Then, the patient may capture medical information in their own home, forwarding the medical information to their doctor or other medical professional through the medical information system, and receive information related to the area of concern without the added inconvenience of going to the doctor's office, thereby saving time and expense.

The authentication and uploading systems, methods and computer-readable storage media technology provide, among other things, a secure way for a user to upload images from a client computing device to the data server of the medical information system, thereby eliminating any potential security risks. For example, following such procedures may prevent transmitting the images to an unauthorized recipient or receiving images from an unauthorized sender.

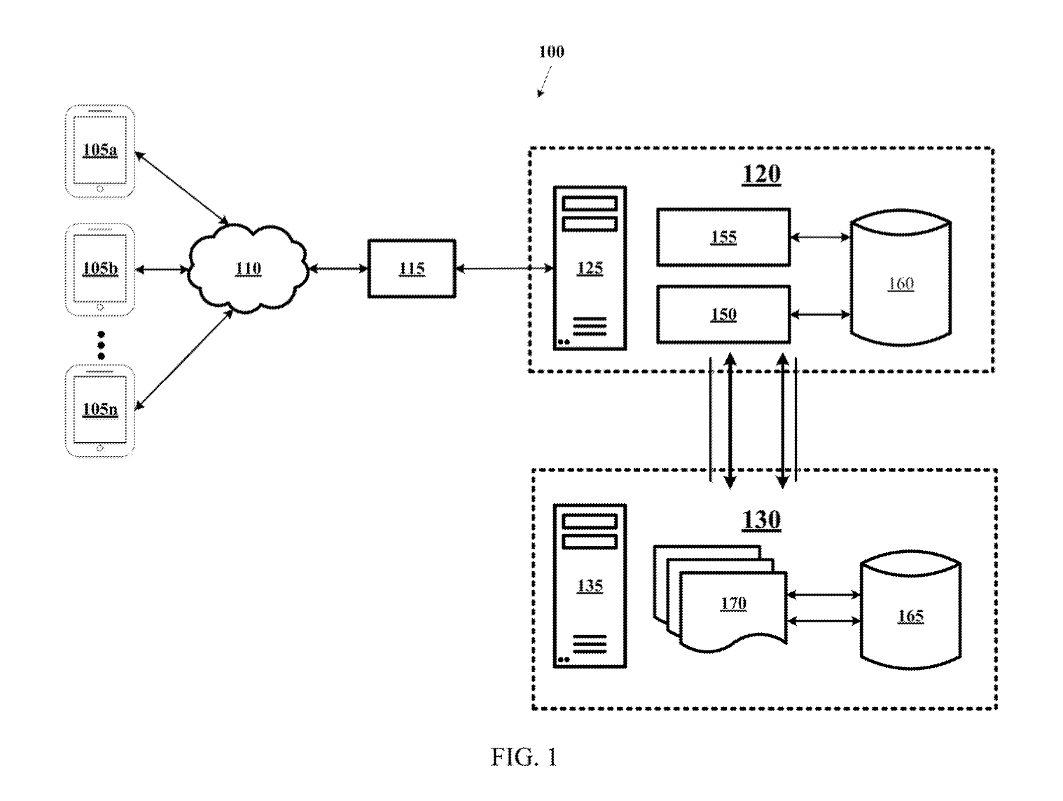

FIG. 1 depicts an illustrative medical information system according to some embodiments. As shown in FIG. 1, a medical information system may include a data network 100 operatively coupled with one or more client computing devices 105a-105n. The client computing devices 105a-105n may be operably coupled to a network 110 through various data connections, such as a wired or wireless data connection, including, without limitation, an Ethernet connection, a local area network connection (for example, a corporate or organization intranet), a wide area network connection (for example, the Internet), mobile communication network connection (for example, third generation (3G), fourth generation (4G), long-term evolution (LTE), or other mobile communications technology), or any other type of data connection known to one of ordinary skill in the art.

The network 110 may be operably connected to a second network 120 via a firewall 115 or other software- or hardware-based network security configuration. The second network 120 may be a secure local area network, such as a hospital or health-care facility intranet, and thus may use the security provided by the firewall. One or more web servers 125 may be operably connected to the network 120. Additionally, a back-end system 130 may be operably connected to the network 120 via a secure connection such as a station-to-station virtual private network. The back-end system 130 may include one or more data servers 135 operably connected to the one or more web servers 125. The back-end system 130 may be configured, among other things, to interact with the client computing devices 105a-105n via the web server 125 to allow for patient identification and medical information capture and/or uploading via the client computing devices. The back-end system 130 may be further configured to interact with various workstations to allow for a user of the workstations to access patient-related information stored on the data server 135. In an embodiment, the patient related information may be maintained as part of a health information system, such as a picture archiving and communications system (PACS). In an embodiment, a patient may access their profile and medical information stored on the medical information system through their client computing device 105a-105n.

As shown in FIG. 1, the web server 125 may be configured to execute various software applications, such as an authentication service 150 and an upload service 155. When executed, the authentication service 150 and the upload service 155 may access a device database 160 to locate and extract information related to the client computing devices 105a-105n. The data server 135 may further include a patient database 165 configured to store medical information and other data received from the client computing devices 105a-105n and/or file servers 170 related to a specific patient. In an embodiment, the patient database 165 may be configured to store a patient profile, or similar data storage structure, for each patient. The patient profiles may be configured to store information associated with the patient, such as patient name and address information, health history, associated client computing devices 105a-105n, healthcare providers, or the like.

It should be noted the arrangement and number of components as shown in FIG. 1 are shown by way of example only. More or fewer components and additional configurations of components may be used depending on the configuration and intended application of the network 100.

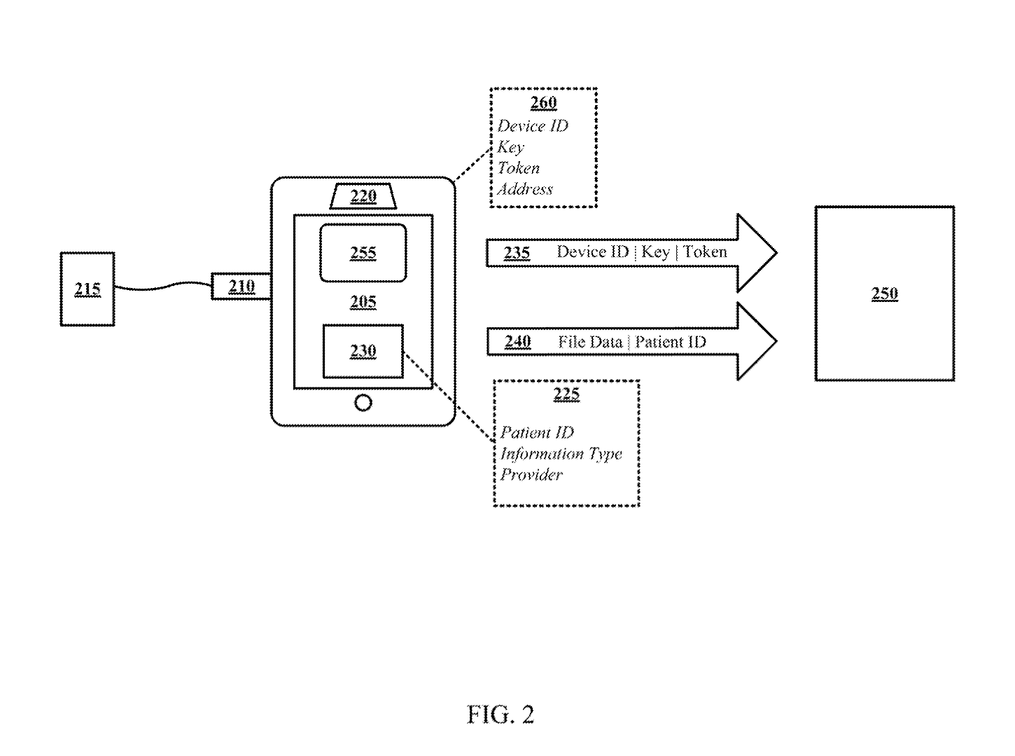

FIG. 2 depicts an illustrative client computing device configured to operate with a medical information system according to some embodiments. As shown in FIG. 2, a client computing device 205 may be configured as a mobile computing device, such as a smartphone or tablet computing device. The client computing device 205 may be configured to access a medical information system application (“system application”) 255. In an embodiment, the system application may be configured as a full application, client application, a web-based application accessible over a network (for example, the Internet), and/or a mobile application (for example, a “mobile app” or “app”). The system application 255 may be configured as an interface for the medical information system 250, that provides modules, routines, applications, or the like operative to establish communication with between the client computing device 205 and the medical information system. The system application 255 may be configured to perform various functions of the medical information system 250 including, without limitation, enrolling and authenticating the client computing device, receiving medical information from the client computing device, data encryption/decryption, and storing and retrieving information from various patient databases.

The client computing device 205 may include various device information capturing elements 220 configured to obtain information. Non-limiting examples of device information capturing elements 220 include cameras, microphones, accelerometers, light sensors, audio sensors, data input devices (for example, a touch screen, a keyboard (physical and/or virtual), or a mouse), location sensors (for example, global positioning system elements, compass, or the like), proximity sensors, gyroscopes, pressure sensors, temperature sensors, or any other type of information capturing element now known or developed in the future. The device information capturing elements 220 may be used alone or in combination with one or more applications (not shown) configured to generate information based on data received from the device information capturing elements 220. For instance, a location sensor and/or accelerometer may be used with an application to generate medical information associated with user movement, such as during exercise or to measure the number of steps and/or distance traveled in a day. In another instance, a user may generate medical entries describing a health issue using a touch screen keyboard and a word processing or note taking application.

The client computing device 205 may additionally include various communication ports 210, including, without limitation, serial (RS232), Ethernet, cellular data network protocols, universal serial bus (USB), Thunderbolt, radio-frequency identification (RFID), Bluetooth, Zigbee, general purpose input/output (GPIO), near-field communication (NFC), or combinations thereof. The communication ports 210 may be configured to operatively couple the client computing device 205 to an external information capturing element 215, including, but not limited to an EKG device, diagnostic imaging device, a blood pressure monitor or cuff, a blood sugar monitor, a pulse oximeter, a stethoscope, a pedometer or other human movement monitor, or the like. In this manner, the system application 255 may be configured to receive medical information from any external information capturing element 215 capable of transmitting information to the client computing device 205.

In an embodiment, the system application 255 may be configured to format information from the various device information capturing elements 220 and/or the external information capturing elements 215 such that the information may be used by the medical information system 250. For example, audio information from a digital stethoscope captured at the client computing device 205 may be formatted into another form, such as a wave form or database record, by the system application 255 and/or at the medical information system 250.

The information captured by the device information capturing elements 220 and/or the external information capturing elements 215 may be configured by the client computing device 205 and/or the system application 255 into medical information 230. The medical information 230 may include various types of electronic and/or digital formats. Illustrative and non-restrictive examples of electronic and/or digital formats include databases, database records, program code, application instructions, and digital files, such as digital documents, websites, multimedia files, audio files, video files, or the like.

The medical information 230 may be associated with medical information metadata 225 configured to provide information about the medical information 230 to the system application 255, other applications operating on the client computing device 205, the medical information system 250, or combinations thereof. Non-limiting examples of medical information metadata 225 include patient identification information, information type (for example, information associated with the form of the information, such as file types and data source), and provider information (for example, doctors and/or healthcare providers associated with the patient and/or medical information 230).

The client computing device 205 may be associated with device information 260 configured to identify the device and/or to provide information for various functions performed by the system application 255 and/or the medical information system 250. Non-limiting examples of device information 260 include device identification information, encryption/decryption keys, network communication tokens, address information, operating system information, hardware information, software information, status information, or the like.

The client computing device 205 may be configured, for instance, through the system application 255, to transmit an authentication request 235 to the medical information system 250. The authentication request 235 may include information associated with the client computing device 205 and/or a patient associated with the client computing device as described herein.

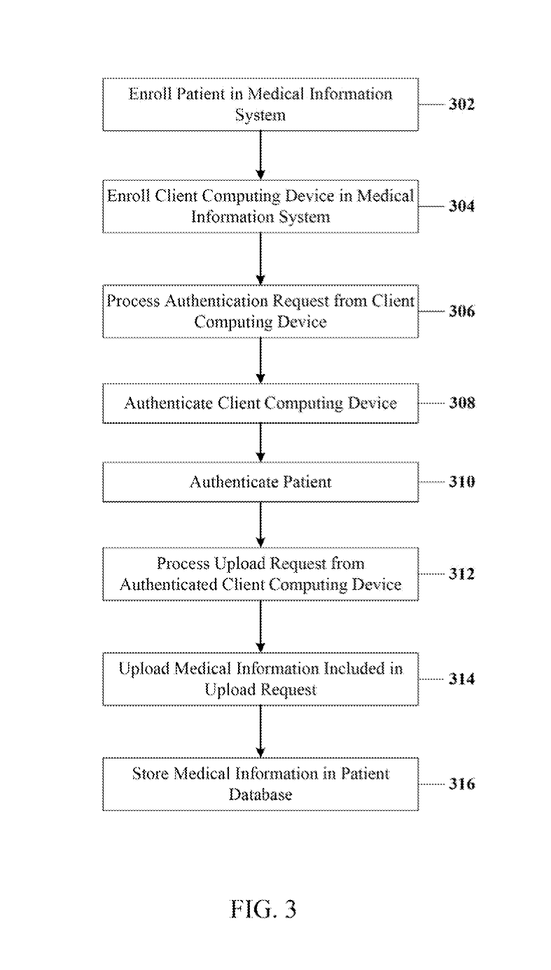

In an embodiment, the authentication request 235 may be configured to request that the medical information system 250 authenticate the client computing device 205 and/or a patient associated with the client computing device, and provide access for the client computing device 205 to upload medical information 230 to the medical information system. As described in more detail in reference to FIGS. 3-5 below, the medical information system 250 may receive the authentication request 235 and authenticate the transmitting client computing device 205 based on information included therein. Once authenticated, the client computing device 205 may also transmit an upload request 240 configured to transmit the medical information 230, along with the medical information metadata 225 to the medical information system 250. The upload request 240 may include information associated with the client computing device 205 and/or a patient associated with the client computing device as described herein. In an embodiment, the authentication request 235 and the upload request 240 are separate requests transmitted by the client computing device 205. In another embodiment, the authentication request 235 and the upload request 240 are included in a single request transmitted by the client computing device 205.

FIG. 3 depicts a flow diagram of an illustrative method of receiving medical information at a medical information system according to an embodiment. As shown in FIG. 3, a patient may be enrolled 302 in the medical information system. For instance, a healthcare provider may register a user with the medical information system, creating a patient record in one or more databases accessible by the medical information system. In an embodiment, patient information may be stored in a patient database of the medical information system. Patient information may include any information associated with the patient, such as patient name, health information (for example, height, weight or the like), medical history, current condition, medical information, security information (for example, passwords, account information, payment information, or the like), doctors and/or healthcare entities associated with the patient, client computing devices associated with the patient, or the like.

Client computing devices may be enrolled 304 in the medical information system. For example, each patient may register one or more computing devices with the medical information system for uploading medical information. In an embodiment, the medical information system and/or an application executing on the client computing device may be configured to automatically register a client computing device. For instance, the medical information system and/or application may include a device registration function configured to register a client computing device that establishes a connection with the medical information system for a patient responsive to receiving certain information. For example, a patient may connect the client computing device to the medical information system and may be prompted to provide certain information, such as passwords and/or account information, in order to enroll 304 the device. Once the client computing device has been enrolled 304, the medical information system may generate a record or other digital profile associated with the client computing device in a device database.

Alternatively, a client computing device may be provided to a patient by a doctor or healthcare provider that is enrolled 304 and pre-configured with patient and client device information. In this manner, the patient may avoid the enrollment and registration process with their own client computing device.

The medical information system may process 306 an authentication request received from a client computing device. For example, the medical information system may parse the authentication request into individual elements, such as a device identifier and an encryption/decryption key. The medical information system may use the information included in the authentication request to determine whether the client computing device transmitting the authentication request is enrolled with the system. For instance, the medical information system may search the device database for a record having a device identifier that matches the device identifier included in the authentication request. If the medical information system determines that the client computing device transmitting the authentication request is enrolled 304 in the medical information system, the medical information system may authenticate 308 the client computing device. The medical information system may transmit a message or other signal to the requesting client computing device indicating whether or not the medical information system was able to authenticate the client computing device.

The medical information system may authenticate 310 the patient associated with the authentication request. For example, the medical information system may use information associated with the client computing device and/or a patient associated with the client computing device to determine whether the patient is enrolled 302 with the medical information system. In an embodiment, the authentication request and/or the upload request may include information such as a device identifier and/or a patient identifier that may be used to locate a patient in the patient database and/or a device in the device database.

In an embodiment, the patient database(s) and the device database(s) may include records with shared fields so that devices and patients may be cross-referenced. For instance, a patient record in a patient database may include “patient ID,” “patient name,” and “client computing device ID(s)” fields, while a device record in a device database may include “client computing device ID” and “patient ID” fields. In this manner, patients may be located based on a patient identifier as well as client computing identifiers associated therewith, and vice versa.

The medical information system may process 312 an upload request received from an authenticated client computing device. For example, the medical information system may decrypt the upload request and/or information contained therein using encryption/decryption information included in the upload request and/or the authentication request processed 306 by the medical information system. The medical information system may extract information from the upload request, such as the medical information, patient identifier information, medical information metadata, or combinations thereof. In an embodiment, the medical information system may format at least a portion of the information included in the upload request, such as medical information file data. The medical information included in the upload request may be uploaded 314 to the medical information system, such as to a data server, including a data server storing a patient database. The medical information system may locate the patient record(s) associated with the patient transmitting the upload request and may store 316 the uploaded 314 medical information in the patient database.

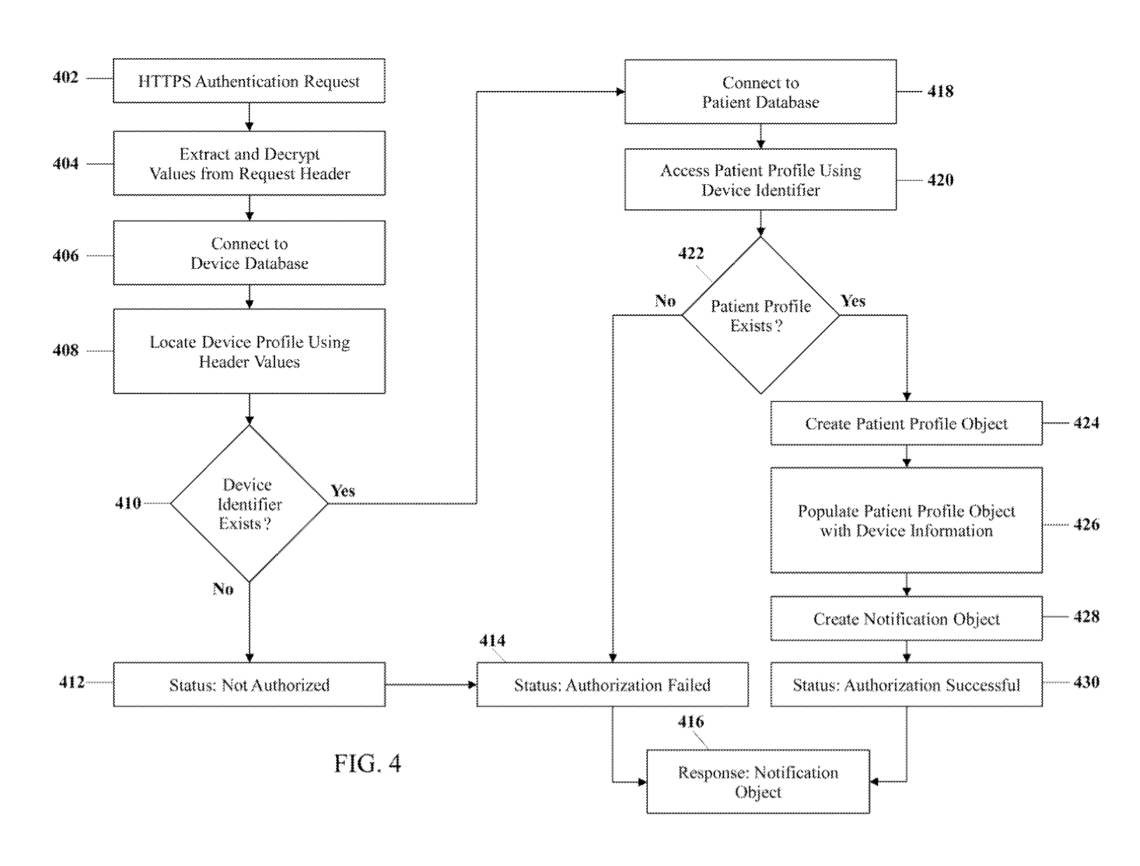

FIG. 4 illustrates a flow diagram of an illustrative process for authenticating a client computing device, such as one of client computing devices 105a-105n as shown in FIG. 1, according to an embodiment. It should be noted that references to FIG. 1 are included in the discussion of FIG. 4 for illustrative purposes only. The process as described in FIG. 4 is not limited to being performed using the network shown in FIG. 1.

The client computing devices 105a-105n may send 402 an initial encrypted authentication request to the web server 125 via the network 110, through the firewall 115. In the embodiment depicted in FIG. 4, the authentication request is configured as a hypertext transfer secure (HTTPS) protocol request. However, embodiments are not limited to HTTPS requests as requests may be communicated using any suitable communication protocol now known to those having ordinary skill in the art or developed in the future.

The web server 125 may receive the authentication request and extract and decrypt 404 the header of the authentication request to determine various values related to the client computing devices 105a-105n. Once the values are identified, the web server 125 may operably connect 406 to the device database 160. The web server 125 may search the database and locate 408 a profile for the client computing devices 105a-105n based upon the header values. The web server 125 may determine if an associated device identifier, as extracted 404 from the header, exists 410 in the device database 160. If the device identifier does not exist, the status of the client computing devices 105a-105n is not verified 412, and the authentication fails 414. The client computing devices 105a-105n may receive a response 416 indicating the authentication failure 414.

If the web server 125 determines the device identifier does exist 410, the web server may connect 418 to the data server 135 in order to access the patient database 165. The web server 125 may access 420 patient profiles stored in the patient database 165 and verify that the patient profile (for example, patient data associated with a patient or patient profile) exists 422. If the patient profile does not exist 422, for instance, the information being received from the client computing devices 105a-105n is not related to an existing patient, the authentication fails 414, and the client computing devices 105a-105n may receive a response 416 indicating the failure. If the patient profile does exist 422, the web server may create 424 a new profile object for the patient. The new profile object may be populated 426 with various information received from the client computing devices 105a-105n such as device settings, application tokens and encryption/decryption keys, device identifiers, and patient data. A notification may be created 428, such as a JavaScript Object Notation (JSON) object, indicating the authentication was successful 430. In an embodiment, the notification may be included in a response 416 transmitted to the client computing devices 105a-105n indicating the successful authentication 430.

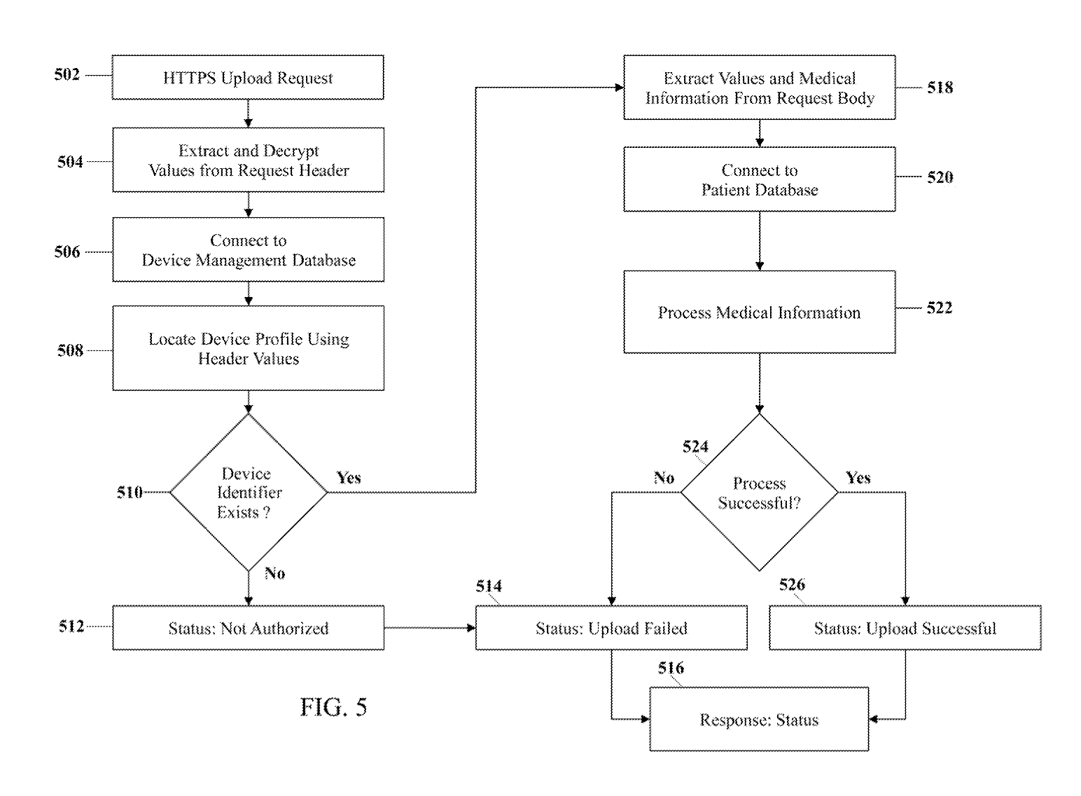

FIG. 5 depicts a flow diagram of an illustrative method for uploading images from a client computing device, such as from one of client computing devices 105a-105n to a web server 125 as shown in FIG. 1, according to an embodiment. Similar to the discussion of FIG. 4, it should be noted that references to FIG. 1 are included in the discussion of FIG. 5 for illustrative purposes only. The process described in FIG. 5 is not limited to being performed using the network shown in FIG. 1.

The client computing devices 105a-105n may send 502 an initial encrypted upload request to the web server 125 via the network 110, through the firewall 115. The web server 125 may receive the upload request and extract and decrypt 504 the header of the upload request to determine various values related to the client computing devices 105a-105n. Once the values are identified, the web server 125 may operably connect 506 to the device database 160. The web server 125 may search the database and locate 508 a profile for the client computing devices 105a-105n based upon the header values. The web server 125 may then determine if an associated device identifier, as extracted 504 from the header, exists 510 in the device database 160, and whether the client computing devices 105a-105n have been previously authenticated. If the device profile does not exist 510 and the client computing devices 105a-105n has not been previously authenticated, the upload of medical information from the client computing devices 105a-105n is not authorized 512, and the upload fails 514. The client computing devices 105a-105n may receive a response 516 indicating the upload failure 514.

If the web server 125 determines the device identifier does exist 510 and the client computing devices 105a-105n have been previously authenticated, the web server may extract 518 values from the request identifying information related to the patient as well as any files in the upload request, such as image data. The web server 125 may connect 520 to the data server 135 in order to access the patient database 165. The web server 125 may process 522 the patient data. The processing 522 may include, without limitation, writing a file to the patient database 165, creating the images in the database, and inserting the image data into the created images. The web server may determine if the processing 522 of the data was successful 524. If the processing 522 was not successful, the upload fails 514, and the mobile device 105 may receive a response 516 indicating the failure. If the processing 522 of the data was successful 524, the web server may create 526 a notification indicating the upload was successful and forward the notification to the client computing devices 105a-105n in a response 516.

It should be noted that the processes as described above in reference to FIGS. 3-5 are shown by way of example. Various steps may be included, repeated, removed, re-ordered, or otherwise altered based upon various conditions, such as operating and/or regulatory standards. For example, various data transmitted between the client computing devices 105a-105n and the web server 125 may require additional security provided, for example, by higher level encryption schemes, such as 128-bit encryption. Similarly, the connection between the web server 125 and the data server 135 may require specific security features such as 128-bit encryption.

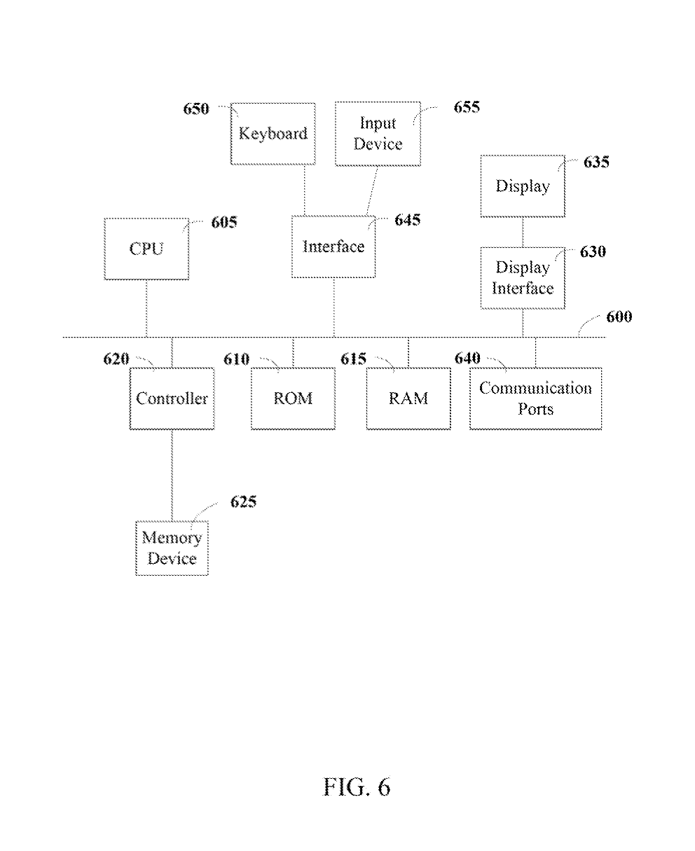

FIG. 6 depicts a block diagram of exemplary internal hardware that may be used to contain or implement program instructions, such as the process steps discussed above in reference to FIGS. 3-5, according to some embodiments. A bus 600 serves as the main information highway interconnecting the other illustrated components of the hardware. CPU 605 is the central processing unit of the system, performing calculations and logic operations required to execute a program. CPU 605, alone or in conjunction with one or more of the other elements disclosed in FIG. 1, is an exemplary processing device, computing device or processor as such terms are using in this disclosure. Read only memory (ROM) 610 and random access memory (RAM) 615 constitute exemplary memory devices.

A controller 620 interfaces with one or more optional memory devices 625 to the system bus 600. These memory devices 625 may include, for example, an external or internal DVD drive, a CD ROM drive, a hard drive, flash memory, a USB drive or the like. As indicated previously, these various drives and controllers are optional devices.

Program instructions, software or interactive modules for providing the digital marketplace and performing analysis on any received feedback may be stored in the ROM 610 and/or the RAM 615. Optionally, the program instructions may be stored on a tangible computer readable medium such as a compact disk, a digital disk, flash memory, a memory card, a USB drive, an optical disc storage medium, such as a Blu-ray™ disc, and/or other recording medium.

An optional display interface 630 may permit information from the bus 600 to be displayed on the display 635 in audio, visual, graphic or alphanumeric format. Communication with external devices may occur using various communication ports 640. An exemplary communication port 640 may be attached to a communications network, such as the Internet or an intranet. Other exemplary communication ports 640 may comprise a serial port, a RS-232 port, and a RS-485 port.

The hardware may also include an interface 645 which allows for receipt of data from input devices such as a keyboard 650 or other input device 655 such as a mouse, a joystick, a touch screen, a remote control, a pointing device, a video input device, and/or an audio input device.

It will be appreciated that various of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the disclosed embodiments.

What is claimed is:

1. A system for securely receiving medical information from at least one client computing device, the system comprising:
a processor; and
a non-transitory, computer-readable storage medium in operable communication with the processor, wherein the computer-readable storage medium contains one or more programming instructions that, when executed, cause the processor to:
receive at least one request from the at least one client computing device, the at least one request comprising authentication information and medical information;
access a device database configured to store device information associated with each client computing device enrolled with the system;
authenticate the at least one client computing device responsive to locating device information associated with the authentication information;
access a patient database responsive to authentication of the at least one client computing device, the patient database configured to store patient information associated with each patient registered with the system;
authenticate a patient responsive to locating an existing patient profile associated with the at least one request in the patient database; and
store at least a portion of the medical information in the existing patient profile.

2. The system of claim 1, wherein the at least one request comprises an authentication request and an upload request.

3. The system of claim 1, wherein the at least one request is configured as a hypertext transfer secure protocol request.

4. The system of claim 3, wherein the authentication information is located within a header of the at least one request.

5. The system of claim 1, wherein the authentication information comprises at least one of the following: a device identifier, a token or an encryption/decryption key.

6. The system of claim 1, further comprising programming instructions that, when executed, cause the processor to:
generate a profile object responsive to authenticating the patient; and
populate the profile object with at least a portion of the authentication information and at least a portion of the medical information.

7. The system of claim 6, wherein the at least a portion of the authentication information comprises at least one of the following: device settings associated with the at least one device, a token, an encryption/decryption key, and a device identifier,
wherein the at least a portion of the medical information comprises patient information.

8. The system of claim 1, wherein the medical information comprises a medical image generated by the patient.

9. The system of claim 8, wherein the medical image is captured using a camera integrated into the at least one client computing device.

10. The system of claim 1, further comprising programming instructions that, when executed, cause the processor to provide access to the at least a portion of the medical information stored in the existing patient profile to a healthcare provider.

11. The system of claim 1, wherein to authenticate the at least one client computing device comprises matching a device identifier for the at least one computing device in the authentication information with an existing device identifier in the device database.

12. A computer-implemented method for securely receiving medical information from at least one client computing device, the method comprising, by a processor:
receiving at least one request from the at least one client computing device, the at least one request comprising authentication information and medical information;
accessing a device database configured to store device information associated with each client computing device enrolled with the system;
authenticating the at least one client computing device responsive to locating device information associated with the authentication information;
accessing a patient database responsive to authentication of the at least one client computing device, the patient database configured to store patient information associated with each patient enrolled with the system;
authenticating a patient responsive to locating an existing patient profile associated with the at least one request in the patient database; and
storing at least a portion of the medical information in the existing patient profile.

13. The method of claim 12, wherein the at least one request comprises an authentication request and an upload request.

14. The method of claim 12, wherein the authentication information comprises at least one of the following: a device identifier, a token or an encryption/decryption key.

15. The method of claim 12, further comprising:
generating a profile object responsive to authenticating the patient; and
populating the profile object with at least a portion of the authentication information and at least a portion of the medical information.

16. The method of claim 12, wherein the medical information comprises a medical image generated by the patient.

17. The method of claim 12, further comprising enrolling the at least one computing device in the device database.

18. The method of claim 12, further comprising formatting at least a portion of the medical information into at least one data format used by the patient database.

19. The method of claim 12, further comprising providing access to the at least a portion of the medical information stored in the existing patient profile to a healthcare provider.

20. The method of claim 12, wherein authenticating the at least one client computing device comprises matching a device identifier for the at least one computing device in the authentication information with an existing device identifier in the device database.
